(19) United States
(12) Patent Application Publication
(10) Pub. No.: US 2010/0006223 A1
(43) Pub. Date: Jan. 14, 2010

(54) USE OF AN ADHESIVE SHEET WITH A CARRIER FILM PROVIDED ON ONE SIDE WITH AN ADHESIVE FOR COVERING MICROTITRE PLATES

(75) Inventors: Thorsten Krawinkel, Hamburg (DE); Christian Ring, Stelle (DE); Maren Kampers, Seevetal (DE)

Correspondence Address: GERSTENZANG, WILLIAM C., 875 THIRD AVE, 8TH FLOOR, NEW YORK, NY, 10022, US

(73) Assignee: Tesa SE, Hamburg (DE)

(21) Appl. No.: 12/493,493

(22) Filed: Jun. 29, 2009

(30) Foreign Application Priority Data
Jul. 11, 2008 (DE) 10 2008 032 568.6

(51) Int. Cl. B32B 37/12

(52) U.S. Cl. 156/327

(57) ABSTRACT

Use of an adhesive sheet having a carrier film provided with an adhesive on one side for covering microtitre plates, the adhesive being formed from at least one acid- or acid anhydride-modified vinylaromatic block copolymer, at least one tackifier resin and at least one metal chelate.

The present invention relates to the use of an adhesive sheet having a carrier film provided on one side with an adhesive for covering microtitre plates.

### BACKGROUND OF THE INVENTION

Microtitre plates are widely used in bioanalytical processes for rapid multiple analysis with a low sample volume. There microtitre plates are typically composed of a plastic plate which comprises a plurality of wells, isolated from one another in rows and columns, which serve as reaction vessels. There are plates with 96 wells, each having a volume of about 0.2 to 0.4 ml, but there also plates with significantly more, and correspondingly smaller, wells.

For the storage and maturation of the various biological processes, these individual wells must be sealed, so that no liquid can be lost and also so that there can be no exchange between the individual wells.

For this purpose, single-sided adhesive sheets are used.

These adhesive sheets are required to possess a sufficient bond strength to adhere sufficiently well, and the sheets must also have a very low water vapour permeability, so that no water is lost during the maturation time. Moreover, following the application, the adhesive sheets ought to be removable again without residues of adhesive, and ought as far as possible to be transparent, in order to allow optical analysis methods as well.

Furthermore, the adhesives on the adhesive sheets ought to possess a certain heat stability, since otherwise, during the maturation processes at high temperatures of almost 100° C., it is easy for creases to form in the sheet, and these creases may result in certain of the wells being open, especially those at the corners.

With a lower tack on the part of the adhesive sheets, it is easier to process them, particularly with latex gloves, of the kind customarily worn in the bioanalytical laboratories.

A new process for the application of the microtitre plates is that of PCR (polymerase chain reaction). PCR is considered a revolutionary method in biochemistry and its possible uses are very diverse—for example, for the detection of diseases and for the development of medicaments (detection of active substances and detection of side reactions).

In the further development represented by real-time PCR, the reaction is monitored in the course of multiplication by means of fluorescent labels.

Additional requirements are imposed on a sealing sheet for real-time PCR analyses—in addition to the imperviousness of the reaction chambers, a high transmittance and low shrinkage on the part of the sheet, in other words minimal creasing during the temperature cycle.

Various adhesives for adhesive sheets which are employed in the stated applications have been described; adhesives based on certain silicones have been found to be particularly advantageous.

U.S. Pat. No. 6,703,120 describes silicone-based adhesives of this kind for this application.

One advantage of these adhesives is that of ensuring good processing properties, on account of the very low tack. Moreover, they possess a high bond strength, and so the loss of liquid by evaporation after 2 weeks of storage is only about 1%.

Disadvantageous features in particular are the high price that must be paid for silicone adhesives, and the difficulty of finding a suitable protective liner, since only release films or papers with fluorosilicone permit a sufficient release effect.

Adhesives with acrylates customarily exhibit too high a permeability for water vapour, and so the water losses are too high.

It is an object of the present invention to provide an adhesive sheet with an adhesive which in turn is outstandingly suitable for sealing reaction vessels, more particularly microtitre plates, and which does not have—or not to the same large extent—the disadvantages of the known adhesives and adhesive sheets, respectively.

### SUMMARY OF THE INVENTION

The invention accordingly provides for the use of an adhesive sheet having a carrier film provided with an adhesive on one side for covering microtitre plates, the adhesive being formed from at least one acid- or acid anhydride-modified vinylaromatic block copolymer, at least one tackifier resin and at least one metal chelate.

### DETAILED DESCRIPTION

Adhesives based on acid-modified vinylaromatic block copolymers which are crosslinked by metal chelates possess a significantly reduced tack as compared with typically employed adhesives based on vinylaromatic block copolymers. Nevertheless, the bond strength is still high enough for these adhesive systems too to achieve an evaporation rate below 1% in use in an adhesive sheet employed for microtitre covering.

Moreover, these adhesives can be detached again with outstanding effect, without leaving residues of adhesive on the microtitre plates. Additionally, when punctured with a syringe, no residues of adhesive remain thereon.

A suitable choice of the tackifier resins that are added makes it also possible to use adhesives which are transparent and colourless, and so optical analysis of the samples, and fluorescence measurement, are not disruptive.

The adhesives are also resistant to certain chemicals used in analysis, especially with respect to polar solvents such as DMSO (dimethyl sulphoxide).

Surprisingly it has been found, therefore, that the use of the adhesives of the invention has produced adhesive sheets which are extremely suitable for microtitre covering, not least for use in PCR.

In contrast to the silicone rubber adhesives, moreover, the adhesives based on vinylaromatic block copolymers can be covered with a normal siliconized release medium such as a paper or a film; a fluorosiliconized liner is not necessary.

A crosslinking of maleic anhydride-modified block copolymers with chelates is known from EP 1 311 559 A2, which describes an increase in the cohesion of the block copolymer mixtures.

Adhesives used are preferably those based on block copolymers comprising polymer blocks formed predominantly of vinylaromatics (A blocks), preferably styrene, and those formed predominantly by polymerization of 1,3-dienes (B blocks), preferably butadiene and isoprene. Both homopolymer and copolymer blocks can be utilized in accordance with the invention. Resulting block copolymers may contain identical or different B blocks. Preferably the block copolymers are partly, selectively or fully hydrogenated. Block copolymers may have a linear A-B-A structure. It is likewise possible to use block copolymers of radial design, and also star-shaped and linear multiblock copolymers. A-B diblock copolymers may be present as further components. Block copolymers of vinylaromatics and isobutylene can likewise be employed in accordance with the invention. All of the aforementioned polymers may be utilized alone or in a mixture with one another.

At least part of the block copolymers employed must be acid-modified or acid anhydride-modified, the modification being accomplished primarily by free-radical graft copolymerisation of unsaturated monocarboxylic and polycarbonic acids or anhydrides such as, for example, fumaric acid, itaconic acid, citraconic acid, acrylic acid, maleic anhydride, itaconic anhydride or citraconic anhydride, preferably maleic anhydride. The fraction of acid and/or acid anhydride is preferably between 0.5 and 4% by weight, based on the overall block copolymer.

Block copolymers of this kind are available commercially, for example, under the name Kraton FG 1901 and Kraton FG 1924 from Kraton, and Tuftec M 1913 and Tuftec M 1943 from Asahi.

The pressure-sensitive adhesive preferably has a fraction of 20% to 70% by weight of vinylaromatic block copolymer, preferably 30% to 60% by weight and more preferably 35% to 55% by weight, % based in each case on the overall adhesive, it not being necessary for the entire fraction of block copolymers to be anhydride-modified and/or acid-modified.

Besides the aforementioned acid-modified or acid anhydride-modified vinylaromatic block copolymers it is also possible for further acids or acid anhydrides to be added, in order to achieve a high degree of crosslinking and hence an even further improved cohesion. In this context it is possible to employ not only monomeric acid anhydrides and acids, as are described in U.S. Pat. No. 3,970,608 A1, but also acid-modified or acid anhydride-modified polymers and also acid anhydride-containing copolymers such as polyvinyl methyl ether-maleic anhydride copolymers, obtainable for example under the name Gantrez, sold by the company ISP.

As tackifiers, adhesives of the invention utilize as their main component, in particular, tackifier resins which are compatible with the elastomer block of the vinylaromatic block copolymers.

Those preferably suitable include unhydrogenated, partially hydrogenated or fully hydrogenated resins based on rosin and rosin derivatives, hydrogenated polymers of dicyclopentadiene, nonhydrogenated or partially, selectively or fully hydrogenated hydrocarbon resins based on C₅, C₅/C₉ or C₉ monomer streams, polyterpene resins based on α-pinene and/or β-pinene and/or δ-limonene, and hydrogenated polymers of preferably pure C₈ and C₉ aromatics. Aforementioned tackifier resins may be used both alone and in a mixture.

For employment in PCR, use is made in particular of those resins which are particularly colourless, ideally hydrogenated hydrocarbon resins based on C₅, C₅/C₉ or C₉.

Further additives which can typically be utilized include the following:
primary antioxidants such as, for example, sterically hindered phenols
secondary antioxidants such as, for example, phosphites or thioethers
in-process stabilizers such as, for example, C radical scavengers
light stabilizers such as, for example, UV absorbers or sterically hindered amines
processing assistance
end block reinforcer resins
fillers such as, for example, silicon dioxide, glass (ground or in the form of beads), aluminium oxides, zinc oxides, calcium carbonates, titanium dioxides, carbon blacks, etc., and also colour pigments and dyes, and also optical brighteners
if desired, further polymers, preferably elastomeric in nature; elastomers which can be utilized accordingly include, among others, those based on pure hydrocarbons, for example unsaturated polydienes such as natural or synthetically produced polyisoprene or polybutadiene, elastomers with substantial chemical saturation such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing or vinyl ether-containing polyolefins, to name but a few
plasticizers such as, for example, liquid resins, plasticizer oils or low molecular mass liquid polymers such as, for example, low molecular mass polybutenes having molar masses <1500 g/mol (number average)

The tack of the pressure-sensitive adhesive may optionally be generated only by thermal activation or by solvent activation.

The metals of the metal chelates may be from main groups 2, 3, 4 and 5 and the transition metals. Particularly suitability is possessed for example by aluminium, tin, titanium, zirconium, hafnium, vanadium, niobium, chromium, manganese, iron, cobalt and cerium. Aluminium and titanium are particularly preferred.

In accordance with one advantageous embodiment of the invention the metal chelates may be represented by the following formula:

(R₁O)ₙM(XR₂Y)ₘ,
where
M is a metal as described above;
R₁ is an alkyl or aryl group such as methyl, ethyl, butyl, isopropyl or benzyl;
n is zero or a larger whole number;
X and Y are oxygen or nitrogen, and in each case may also be attached through a double bond to R₂;
R₂ is an alkylene group which joins X and Y and which may be branched and/or may contain oxygen or further heteroatoms in the chain;
m is a whole number, but at least 1.

Preferred chelate ligands are those formed from the reaction of the following compounds: triethanolamine, 2,4-pentanedione, 2-ethyl-1,3-hexanediol or lactic acid.

Particularly preferred crosslinkers are aluminium acetylacetonates and titanium acetylacetonates.

The ratio selected between the acid and/or acid anhydride groups and the acetylacetonate groups ought to be approximately equivalent in order to achieve optimum crosslinking, although a small excess of crosslinker has emerged as being positive.

The ratio between anhydride groups and acetylacetonate groups may, however, be varied; in that case, for sufficient crosslinking, neither of the two groups should be present in more than a five-fold molar excess.

The adhesives of the invention display particularly good adhesion to polypropylene and polystyrene, the materials from which the microtitre plates are customarily produced.

As a result of the crosslinking with the metal chelates, the block copolymer adhesives do not soften at relatively moderate temperatures, but instead withstand intact the customary processes which are carried out with the microtitre plates, such as heating to 90° C. and storage at −40° C., without severe creasing of the sheets.

The carrier of the adhesive sheet is typically composed—depending on the tear strength and transparency requirements—of polypropylene or polyethylene terephthalate. Applications with an aluminium foil as carrier, or with an aluminium-coated film, are also conceivable, however.

Preferably both the adhesive and the carrier film are transparent, such that the transparent adhesive sheet preferably has a transmittance of greater than 60%, more particularly a transmittance of greater of 90% at a wavelength of 350 to 1150 nm.

The degree of transmission—occasionally referred to as transmittance, and generally reported in %—is the ratio of the light output that arrives at the reverse of a body through which light passes to the light output that is incident on the front. The transmittance is curtailed by reflection and absorption.

It is therefore the case that: transmittance=(1−reflectance)×(1−absorption).

In the text below, the invention is explained in more detail with reference to examples, without any intention that the invention should in any way be restricted as a result.

### EXAMPLES

The preparation and processing of the pressure-sensitive adhesives (PSAs) may take place from solution and from the melt. It is particularly preferred, however, to manufacture the PSAs from solution, in order to prevent premature crosslinking.

Production of Specimens:

The constituents are dissolved in a 40:40:20 mixture of toluene/benzine/isopropanol, to give a solids content of 40% by weight. Shortly before the coating operation, the metal chelate, in solution at 10% by weight in toluene, is then added and is distributed homogeneously by stirring. The specimens are then coated out onto a PET film 23 μm thick and are dried at 110° C. to leave a weight of 50 g/cm² of adhesive per unit area.

Composition of the examples: see Table 1.

TABLE 1

| | 1 | 2 | 3 | C4 |
|---|---|---|---|---|
| Kraton FG 1901 | 100 | 40 | 40 | |
| Kraton FG 1924 | | 60 | 60 | |
| Kraton G 1652 | | | | 100 |
| Regalite R 1100 | 100 | 100 | | 100 |
| Escorez 5600 | | | 120 | |
| Shellflex 371 | 20 | 20 | | 20 |
| Kristalex 1140 | | 10 | | |
| Aluminium | 1 | 1 | 1 | |
| acetylacetonate | | | | |

Amounts each in weight fractions

Properties of the raw materials employed:
Kraton FG 1901 SEBS (styrene-ethylene/butylene-styrene block copolymer), 100% triblock, block polystyrene content: 30% by weight, modified with about 2% by weight of maleic anhydride, Kraton Polymers
Kraton FG 1924 SEBS (styrene-ethylene/butylene-styrene block copolymer), about 41% by weight diblock, block polystyrene content: 13% by weight, modified with about 1.3% by weight of maleic anhydride Kraton Polymers
Kraton G 1652 SEBS (styrene-ethylene/butylene-styrene block copolymer), 100% triblock, block polystyrene content: 30% by weight, no acid modification, Kraton Polymers
Regalite R 1100 hydrogenated C₉ resin with a softening point of about 100° C., Eastman Chemicals
Eastotac 100 W hydrogenated C₅ resin with a softening point of about 100° C., Eastman Chemicals
Shellflex 371 naphthenic oil, Shell
Kristalex 1140 pure aromatic resins as end block reinforcer, with a softening point of about 140° C., Eastman

### Bond Strength Measurement

The peel strength (bond strength) was tested in accordance with PSTC-1.

A strip 2 cm wide of a specimen produced as described above was adhered to a steel plate or polystyrene plate by rolling over it back and forth three times with a 2 kg roller. The plate was clamped in and the pressure-sensitive adhesive strip was peeled from its free end at a peel angle of 180° using a tensile testing machine, with a speed of 300 mm/min.

### Liquid Losses

All 96 wells of a microtitre plate were filled with 50 μl each of a coloured aqueous solution. The surface of the plate was rubbed dry with a lint-free cloth to remove adhering droplets of liquid.

The plate was then sealed with the adhesive sheet of the invention, the sheet being applied centrally to the plate and pressed down well all round with an applicator customary for this purpose. The weight of the plate was determined on an analytical balance.

A temperature program was run of

1: 94° C. 2 min

2: 94° C. 15 s

3: 50° C. 15 s

4: 72° C. 30 s

5: 72° C. 2 min

with steps 2 to 4 being repeated 30 times.

The plates were then conditioned at 22° C. After a visual check as to whether all of the wells were still filled, the specimens were weighed again after 24 h.

The evaporation was subsequently calculated as a percentage.

### Removal of the Storage

The bonded specimens from the preceding test, after cooling to room temperature, were slowly removed by hand. A check was made for residues of adhesive bonded to the microtitre plate.

### Resistance to DMSO

Instead of the coloured aqueous solution, a solution of 5% by weight of DMSO in water was used, the microtitre plates being held overhead more frequently in order to produce wetting of the adhesive tape with the DMSO solution.

An examination was made for whether the adhesive tapes underwent any change, such as swelling, for example.

### Transparency

The transparency of the completed products was measured by ASTM-D 1003-61, method A.

The following adhesive data were determined for the exemplary adhesive sheets:

| | Bond | Bond | | | |
|---|---|---|---|---|---|
| | strength | strength to | | | |
| | to steel | polystyrene | Removal | Liquid losses | |
| | instantaneous | instantaneous | after 90° C. | after storage | |
| PSA from | in | in | storage for 1 | in % by | Resistance to |
| Example | N/cm | N/cm | week | weight | DMSO |
| 1 | 3.6 | 2.7 | No residues | 1.5 | o.k. |
| 2 | 5.2 | 4.7 | No residues | 1.2 | o.k. |
| 3 | 4.1 | 3.6 | No residues | 0.9 | o.k. |
| C4 | 3.9 | 2.5 | Strings of | 5.3 | o.k. |
| | | | adhesive | Some | |
| | | | Residues | reaction | |
| | | | | vessels open | |

As is apparent, there are no residues in the microtitre plate in the case of the specimens with crosslinked vinylaromatic block copolymers. Although the bond strengths are very low here, there is no detachment of the adhesive sheets, as in visible from the low evaporation values. Without crosslink systems (Example C4), there is severe creasing and hence the opening of some of the reaction vessels, as can be seen from the higher evaporation rate.

1. A method for covering a microtitre plate, which comprises covering said microtitre plate with an adhesive sheet having a carrier film provided with an adhesive on one side, the adhesive being formed from at least one acid- or acid anhydride-modified vinylaromatic block copolymer, at least one tackifier resin and at least one metal chelate.

2. Method according to claim 1, wherein the metal chelate is a metal chelate represented by the formula:
(R₁O)ₙM(XR₂Y)ₘ,
where
M is a metal from main group 2, 3, 4 or 5 or a transition metal;
R₁ is an alkyl or aryl group;
n is zero or a greater whole number,
X and Y are oxygen or nitrogen, which in each case is optionally attached through a double bond to R₂;
R₂ is an alkylene group which connects X and Y and which optionally is branched and/or optionally contains oxygen or further heteroatoms in the chain;
m is an integer, but is at least 1.

3. Method according to claim 1, wherein the metal chelates are aluminium acetylacetonates or titanium acetylacetonates.

4. Method according to claim 1, wherein the adhesive comprises of 20% to 70% by weight of vinylaromatic block copolymer based on the total weight of adhesive, optionally not all of which vinylaromatic block copolymer is in anhydride-modified and/or acid-modified form.

5. Method according to claim 1, wherein the vinylaromatic block copolymers comprise styrene block copolymers.

6. Method according to claim 1, wherein the fraction of acid and/or acid anhydride is between 0.5% and 4% by weight, based on the total weight of block copolymer.

7. Method according to claim 1, wherein the adhesive comprises further elastomers and/or further acids or acid anhydrides.

8. Method according to claim 1, wherein the block copolymers are at least partly hydrogenated.

9. Method according to claim 1, wherein said at least one tackifier resin is selected from the group consisting of hydrogenated hydrocarbon resins based on C₅, C₅/C₉ or C₉.

10. Method according to claim 1, wherein the carrier film is a polypropylene film, a polyethylene terephthalate film or an aluminium foil or is an aluminium-coated film.

11. Method of claim 2, wherein R₁ is methyl, ethyl, butyl, isopropyl or benzyl.
